(19) United States
(12) Patent Application Publication
(10) Pub. No.: US 2013/0168521 A1
(43) Pub. Date: Jul. 4, 2013

(54) MECHANISM FOR HOLDING A BALL

(71) Applicants: CHE-HAU WU, TAICHUNG (TW); YING-LUNG LIN, TAICHUNG (TW); HSIEN-FENG LIU, TAICHUNG (TW)

(72) Inventors: CHE-HAU WU, TAICHUNG (TW); YING-LUNG LIN, TAICHUNG (TW); HSIEN-FENG LIU, TAICHUNG (TW)

(73) Assignee: PRECISION MACHINERY RESEARCH & DEVELOPMENT CENTER, TAICHUNG (TW)

(21) Appl. No.: 13/338,397

(22) Filed: Dec. 28, 2011

(51) Int. Cl. F16M 13/00

(52) U.S. Cl. 248/346.04

(57) ABSTRACT

A ball holding mechanism comprises a base with a central axis disposed from bottom to top with an urging block, an elastic element, and a stopping block. The surrounding of the base is pivotally provided with several holding arms, each of which has a transmission end and a holding end. The transmission end urges against the bottom surface of the urging block. By using the lever principle, the urging blocks are controlled by an adjusting mechanism to make a downward displacement along the central axis to push the transmission ends so that the holding ends perform a holding action while the elastic element keeps flexibility after the ball is held. A pivoting base can rotate in the horizontal and longitudinal direction on the holding arm through two horizontal and longitudinal shafts pivotally mounted on the holding end.

### BACKGROUND OF THE INVENTION

1. Field of Invention

The invention relates to a ball holding mechanism and, in particular, to a holding mechanism that utilizes the lever principle to control the force of holding a

2. Related Art

As shown in FIG. 10, a conventional ball holding mechanism includes a base 6 around which several holding arms are provided. Each of the holding arms is an elastic chip 7 that is resilient to deformation. One end of the holding arm is fixed to the base 6. The other end is the holding end 71 for holding a ball 8 on the inner side of the elastic chips 7. When a ball 8 is disposed to the inner side of the elastic chips 7, the ball 8 pushes the elastic chips 7 outward. In this case, the elastic chips 7 produce a resilient force to hold the ball 8 and position it at the center.

However, the elastic force provided by the elastic hips 7 to hold the ball 8 is determined by the material properties of the elastic chips 7. The properties are fixed since the elastic chips 7 are manufactured and cannot be adjusted dynamically. This is inconvenient in holding balls.

### SUMMARY OF THE INVENTION

An objective of the invention is to provide a ball holding mechanism. By fastening an adjusting nut on a screw bar, an urging block presses the hook part at the end of a holding arm. The lever principle is utilized to rotate the top end of the holding arm inward, thereby achieving the holding effect.

Another objective of the invention is to use a double shaft co-pointed pivoting mechanism provided at the top end of the holding arm for the pivotal base on the holding arm to produce two degrees of freedom for small rotations. This achieves the effect of auto-centering for the held ball.

To achieve the above objectives, the disclosed ball holding mechanism includes a base, several holding arms, and several double shaft co-pointed pivoting mechanisms.

The base has a top surface and a bottom surface. The base is provided with a central axis mounted from top to bottom with an urging block and an elastic element. The top end of the central axis is provided with a stopping block. The urging block has atop surface and a bottom surface. The urging block is controlled by an adjusting mechanism to slide ups and downs along the central axis. The bottom end of the elastic element urges against the top surface of the urging block. The top end of the elastic element urges against the bottom end of the stopping block. The surrounding of the base is extended with several pivotal connection bases at equal angular interval.

Each of the holding arms has a transmission end and a holding end, between which is provided with a pivotal connection part. Each of the holding arms is pivotally connected to the corresponding pivotal connection base on the base via the pivotal connect on part thereof. The transmission end of each of the holding arms urges against the bottom surface of the urging block. When the urging block slides downward along the central axis, the urging block pushes each of the transmission ends to rotate the holding arms inward, thereby holding the ball disposed on the inner side of the holding arms.

The double shaft co-pointed pivoting mechanism is disposed at the holding end of each of the holding arms. The holding end expands to form a pair of sub-arms on the left and right sides. Each of the two sub-arms is formed with a first axial hole opposite to each other. The double shaft co-pointed pivoting mechanism includes a first shaft, a second shaft and a pivoting base. The first shaft is horizontally and pivotally inserted in the first axial holes of the two sub-arms. The first shaft is formed with a second axial hole in the longitudinal direction. The pivoting base has a first side and a second side opposite to each other. The first side is fixed with a ball recess for contacting and holding a ball. The second side is protruded with a pivotal part formed with a third axial hole in the longitudinal direction. The pivoting bases face each other by the first sides thereof They are mounted on the holding ends of the corresponding hold arms. Their pivotal parts go through between the two sub-arms of each of the holding arms. The second shaft goes through the third axial hole of the pivotal part of the pivoting base and the second axial hole of the first shaft. The pivoting base is pivotally connected to the first shaft. The top ends of the two sub-arms of the holding arm is provided with an elastic chip, with which the pivoting base can perform small rotations in the horizontal and longitudinal directions on the holding arm.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional view of the first embodiment of the invention;

FIGS. 2, 3, and 4 are exploded views of t of the first embodiment;

FIG. 5 is a longitudinal cross-sectional view of the first embodiment;

FIG. 6 is a cross-sectional view of the first embodiment, showing the holding action of the holding arm;

FIG. 7 is a cross-sectional view of the first embodiment, showing the longitudinal rotation action of the pivoting base;

FIG. 8 is a cross-sectional view of the first embodiment, showing the horizontal rotation action of the pivoting base;

FIG. 9 is a cross-sectional view of part of the second embodiment; and

FIG. 10 is a three-dimensional view of a conventional ball holding mechanism.

### DETAILED DESCRIPTION OF THE INVENTION

The present invention will he apparent from the following detailed description, which proceeds with reference to the accompanying drawings, wherein the same references relate to the same elements.

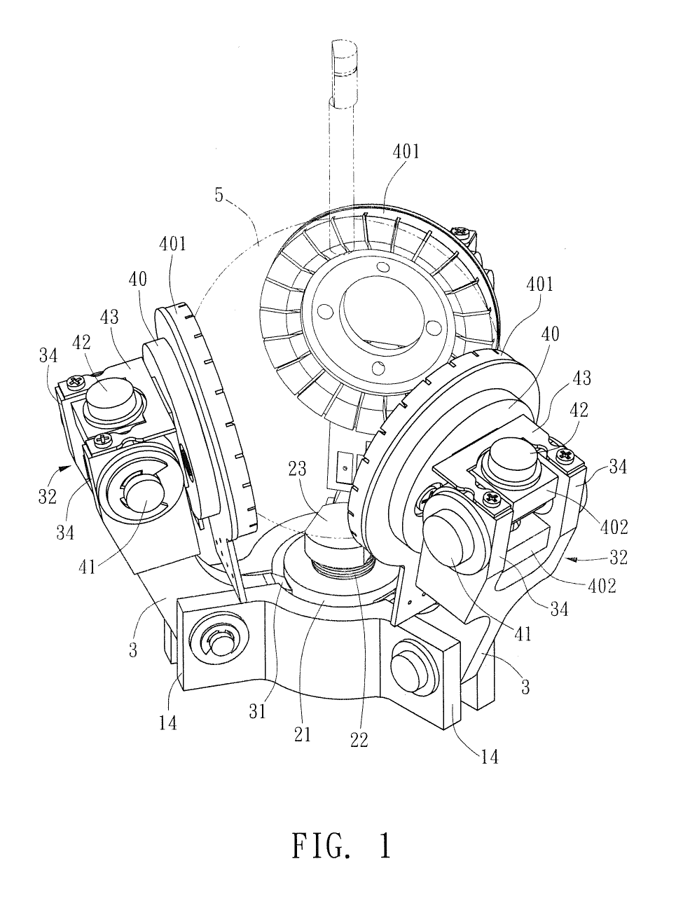

Please refer to FIGS. 1 to 8. The first embodiment of the disclosed ball holding mechanism includes: a base 1 and three holding arms 3.

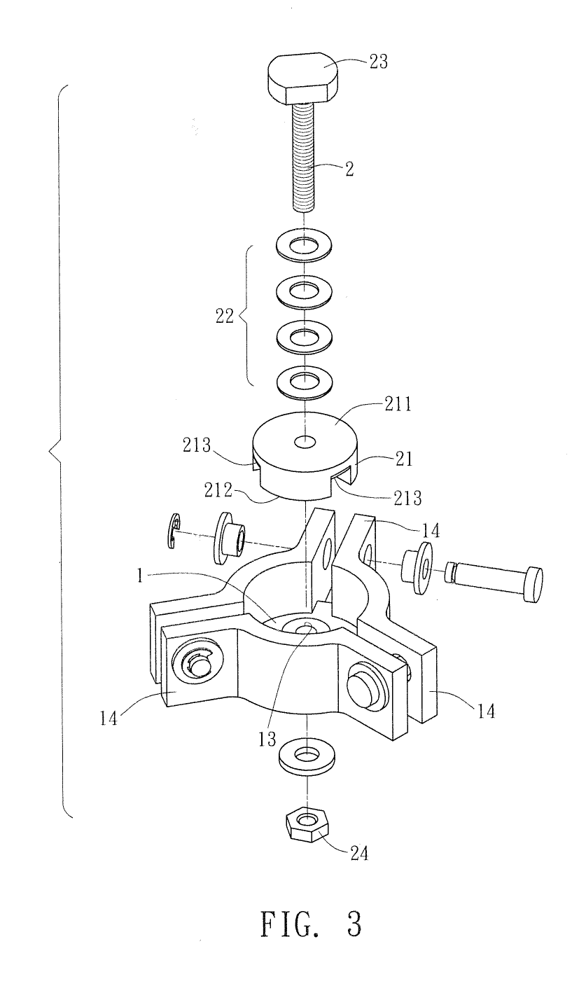

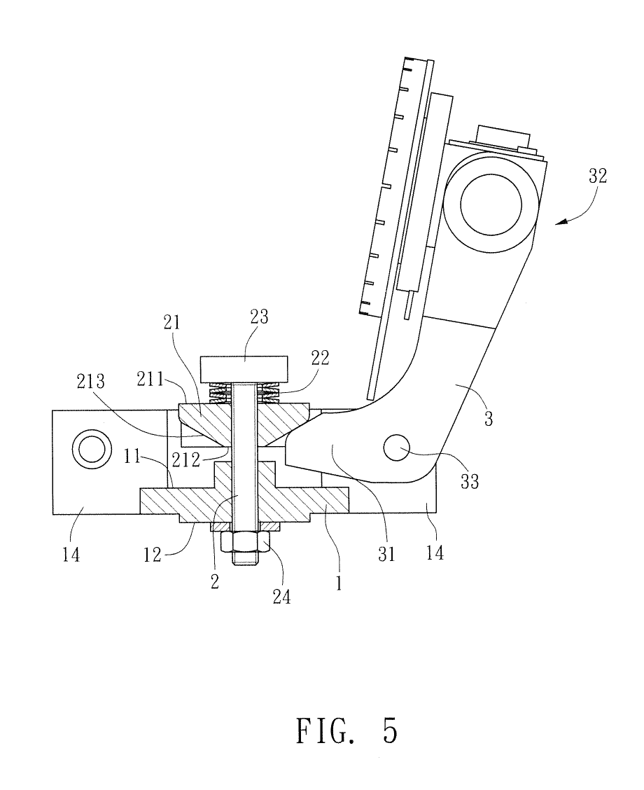

As shown in FIGS. 3 and 5, the base 1 has a top surface 11 and a bottom surface 12. A through hole 13 goes from the top surface 11 to the bottom surface 12 of the base 1. A central axis is inserted in the through hole 13. In this embodiment, the central axis is a screw bar 2. The part of the screw bar above the top surface 11 of the base 1 is mounted from bottom to top with an urging block 21 and an elastic element. The top end of the screw bar 2 is fixed with a stopping block 23. The urging block 21 has a top surface 211 and a bottom surface 212. In this embodiment, the elastic element is a disk spring 22 whose bottom end urges against the top surface 211 of the urging block 21 and whose top end urges against the bottom end of the stopping block 23. The part of the screw bar 2 below the bottom surface 12 of the base 1 is screwed with a nut 24 and urges against the bottom surface 12 of the base 1. When rotating the nut 24 upward along the screw bar 2, the screw bar 2 makes the stopping block 23 to have a downward displacement because the nut 24 has urged against the bottom surface 12 of the base 1. The urging block 21 also makes a downward displacement along the screw bar 2. The surrounding of the base 1 is expanded with several pivotal connection bases 14 at equal angular interval. In this embodiment, there are three pivotal connection bases as an example.

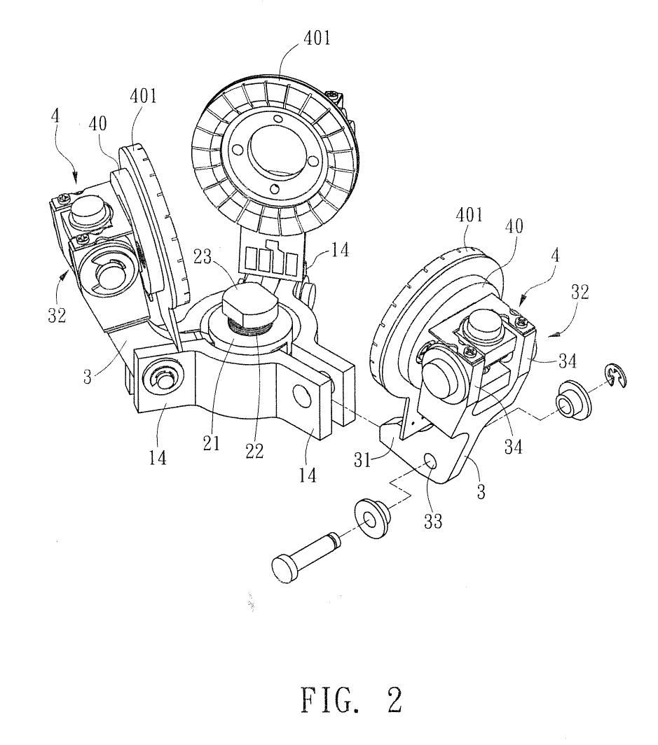

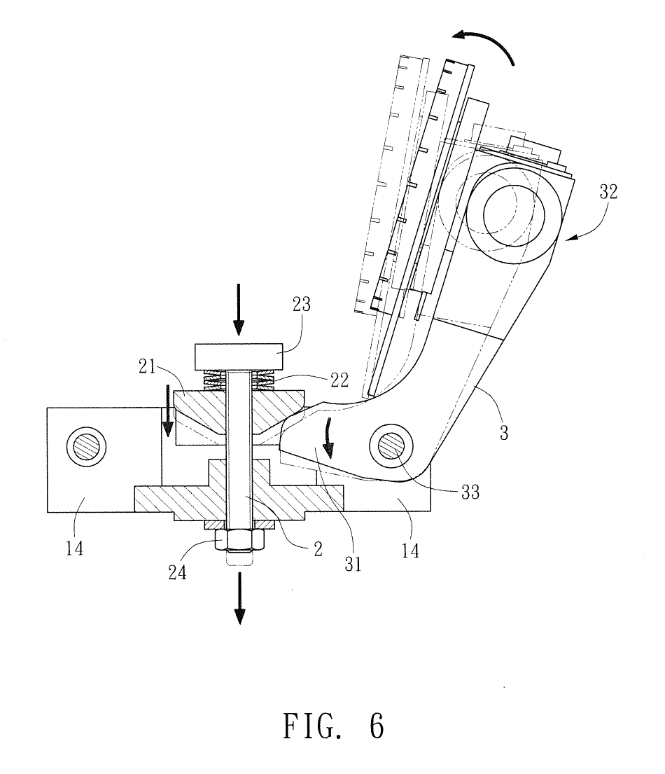

As shown in FIGS. 2 and 5, each of the holding arms 3 has a transmission end 31 and a holding end 32. A pivotal connection part 33 is provided between the transmission end 31 and the holding end 32. Each of the holding arms 3 is pivotally connected to the corresponding pivotal connection base 14 around the base 1 via the pivotal connection part 33 thereof. The transmission end 31 of each of the holding arms 3 urges against the bottom surface 212 of the urging block 21. When the nut 24 is rotated to push the urging block 21 to make a downward displacement along the screw bar 2, as shown in FIG. 6, the urging block pushes each of the transmission ends 31 so that the holding arms 3 rotate inward using the corresponding pivotal connection parts 33 as the axes. Thus, the holding arms 3 hold the ball disposed on the inner side thereof As shown in FIGS. 3 and 5, the bottom surface 212 of the urging block 21 has a skewed cavity 213 with a suitable depth at the place urged by the transmission end 31 of the corresponding holding arm 3. The transmission end 31 of each of the holding arms 3 goes through the corresponding skewed cavity 213 and urges thereon. This can change the inclined angle of the holding arms 3.

As shown in FIG. 6, the invention utilizes the lever principle. By rotating the nut 24 to push the urging block 24 to make a downward displacement, thereby pushing the transmission end 31 of the holding arm 3, the holding arms 3 rotate with respect to the pivotal connection parts 33 to hold the ball 5 disposed on the inner side of the holding arms 3. Making an angular displacement for the nut 24 adjusts the holding force of the holding arms 3. By rotating the nut 24 to make a larger downward displacement for the urging block 24, the rotating angle of the holding ends 32 of the holding arms 3 inward also increases. The holding force imposed on the ball increases accordingly. However, the ball may be a precision machine. If the force imposed thereon is too large, the ball may be damaged. Therefore, the invention uses the disk spring 22 disposed between the urging block 21 and the stopping block 23 as a buffer structure. The ball 5 still has some flexibility while being held.

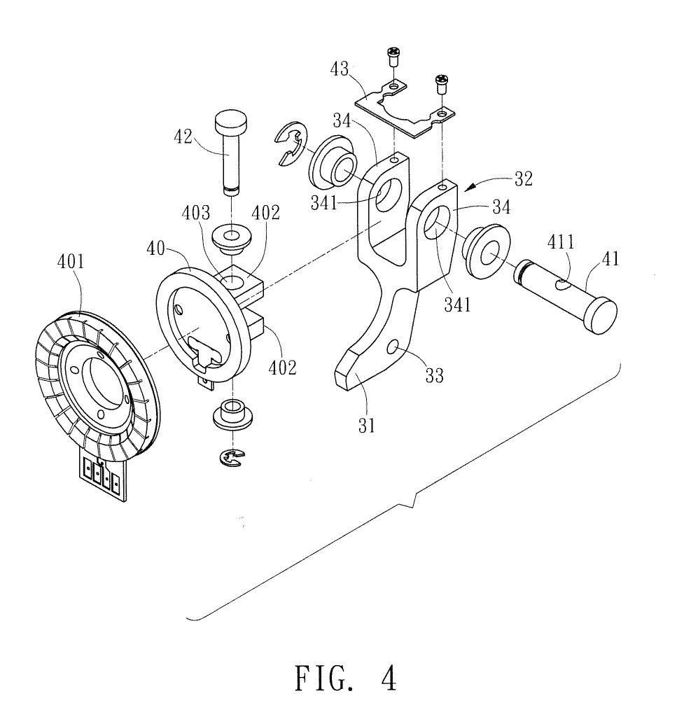

Furthermore, as shown in FIGS. 2 and 4, the holding end 32 of each of the holding arms 3 has a double shaft co-pointed pivoting mechanism 4. The holding end 32 expands to form a pair of sub-arms 34 on opposite sides. The two sub-arms 34 are formed with first axial holes 341 opposite to each other. The double shaft co-pointed pivoting mechanism 4 includes a first shaft 41, a second shaft 42, and a pivoting base 40. The first shaft 41 is horizontally and pivotally inserted in the first axial holes 341 of the two sub-arms 34. The first shaft 41 is formed with a second axial hole 411 in the longitudinal direction. One side of the pivoting base 40 is fixed with a ball recess 401 with a shape corresponding to and in close contact with the ball. The opposite side is protruded with a pivotal part. In this embodiment, the pivotal part is a pair of opposite protruding blocks 402. The two protruding blocks 402 arc formed with third axial holes 403 in the longitudinal direction. The pivoting bases 40 face each other by the ball recesses 401 thereof and are disposed on the holding ends 32 of the holding arms 3. The protruding blocks 402 of the pivoting bases 40 go through between the two sub-arms 34 of the holding arm 3. The two protruding blocks 402 are on the upper and lower sides of the first shaft 41. The second shaft 42 goes through the third axial holes 403 of the two protruding blocks 402 of the pivoting base 40 and the second axial hole 411 of the first shaft 41, thereby pivotally connecting the pivoting base 40 on the first shaft 41. The top ends of the two sub-arms 34 of the holding arm 3 are provided with an elastic chip 43.

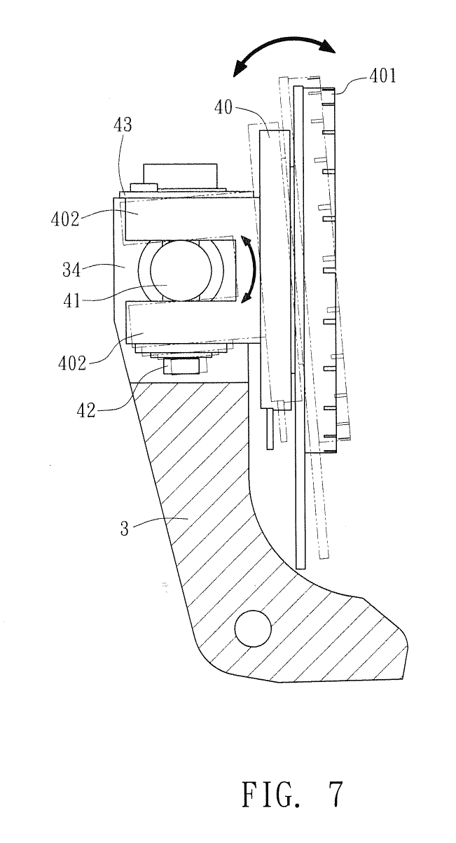

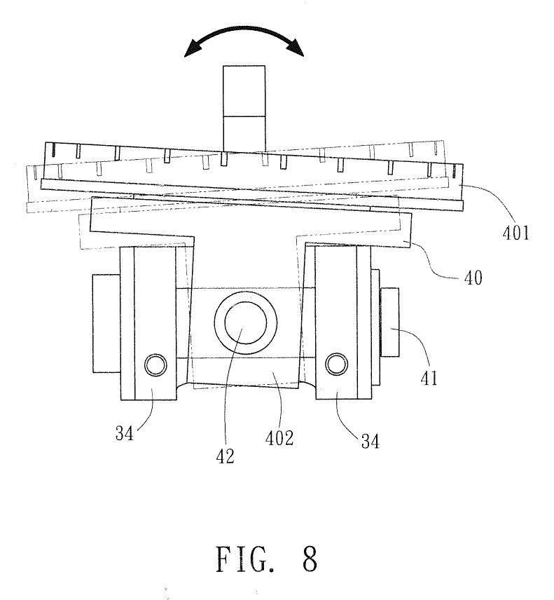

With the above-mentioned double shaft co-pointed pivoting mechanism 4, the pivoting base 40 rotates with respect to the first shaft 41 in the longitudinal direction on the holding end 32 of the holding arm 3, as shown in FIG. 7. It can also rotate in the horizontal direction with respect to the second shaft 42, as shown in FIG. 8. The rotations in these two directions are restricted by the two sub-arms 34 on the left and right sides of the two protruding blocks 402 and the elastic chip 43 above so that the rotations are small. The elastic chip 43 also provides some flexibility to the double shaft co-pointed pivoting mechanism 4.

When the three holding arms 3 hold a ball with the ball recesses 401 and the position of the ball is not centered, then the three holding arms 3 impose different forces on the ball during the holding process. The net force in this case is not zero, resulting in pushing the ball along the direction of the net force. During the process of moving the ball, the double shaft co-pointed pivoting mechanism of the pivoting base 40 and the ball recess 401 with the corresponding shape of the ball can automatically fine-tune the angles of the pivoting bases 40, until the net force imposed by the three holding arms 3 is zero and the ball is at the center. The invention thus achieves the auto-centering effect for the ball.

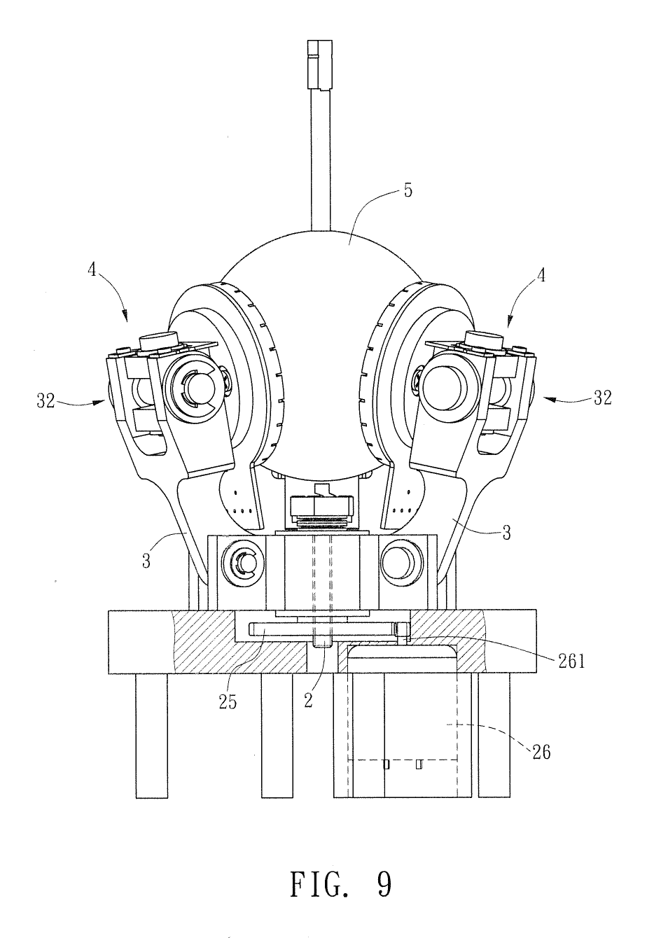

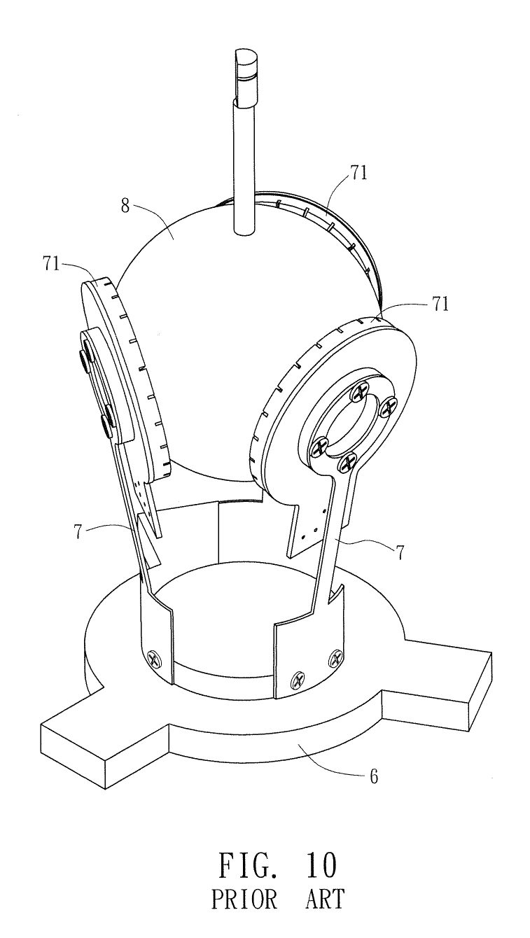

FIG. 9 shows the second embodiment of the invention. It differs from the first embodiment in a different method of controlling the screw bar 2 to push the urging block 21 to make a downward displacement. In this embodiment, the part of the screw bar 2 below the bottom surface 12 of the base 1 is screw-connected with a transmission device, such as a gear or a belt wheel. This embodiment uses a gear 25 as an example. The gear 25 urges against the bottom surface 12 of the base 1 from below. A dynamical driving device, such as a motor 26, engages with the gear 25 with a transmission axis 261 with teeth. When the transmission axis 261 of the motor 26 rotates, the gear 25 is brought into rotation as well. As in the first embodiment, the gear 25 urges against the bottom surface 12 of the base 1 so that the screw bar 2 makes a downward displacement, making the holding arms 3 to have a holding action. An advantage of this embodiment is that the rotation of the motor 26 automatically controls the holding arms 3. In practice, the invention can be equipped with other precision sensors to measure the force required to hold a ball. With such electronic signals, the motor 26 can be more precisely controlled to maneuver the holding arms 3.

In summary, the invention has the following advantages and effects:

1. The invention utilizes the lever principle. By rotating the nut 24 on the screw bar 2 or using the motor 26 to drive the gear 25, the urging block 21 makes a downward displacement to push the transmission ends 31 of the holding arms 3. The holding arms 3 then rotate with respect to the corresponding pivotal part 33, thereby holding the ball on the inner side of the holding arms 3. The angular displacement in the nut 24 or the gear 25 adjusts the holding force of the holding arms 3.

2. According to the invention, the deformation of the disk spring 22 between the stopping block 23 and the urging block 21 provide the flexibility of the holding mechanism, preventing the ball from damages.

When the ball is not centered, the three holding arms 3 of the invention impose different forces on the ball, resulting in a nonzero net force. The two degrees of freedom of the double shaft co-pointed pivoting mechanism 4 on each of the three holding arms 3 enables the double shaft co-pointed pivoting mechanism 4 to rotate themselves and the ball recess 401 with the corresponding shape of a ball to automatically center the ball.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A ball holding mechanism, comprising:
a base, which has a top surface and a bottom surface and is formed with a central axis mounted from bottom to top an urging block and an elastic element; wherein the top end of the central axis is provided with a stopping block, the urging block has a top surface and a bottom surface; the urging block is controlled by an adjusting mechanism to make a displacement along the central axis, the bottom end of the elastic element urges against the top surface of the urging block; the top end of the elastic element urges against the bottom end of the stopping block, and the surrounding of the base is expanded with several pivotal connection bases at equal angular interval;
a plurality of holding arms, each of which has a transmission end and a holding end with a pivotal connection part interposed between the transmission end and the holding end; wherein each of the holding arms is pivotally connected to the corresponding pivotal connection base via the pivotal connection part thereof; the transmission end of each of the holding arms urges against the bottom surface of the urging block; and when the urging block is controlled to make a downward displacement along the central axis the urging block pushes the transmission ends so that the holding arms rotate inward to hold a ball disposed on the inner side of the holding arms; and
a plurality of double shaft co-pointed pivoting mechanisms, each of which is provided on the holding end of each of the holding arms; wherein the holding end expands to form a pair of opposite sub-arms, the two sub-arms have respectively a first axial hole opposite to each other, the double shaft co-pointed pivoting mechanism includes:
a first shaft, a second shaft, and a pivoting base;
wherein the first shaft is horizontally and pivotally inserted in the first axial holes and is formed with a second axial hole in the longitudinal direction; the pivoting base has a first side and a second side opposite to each other, the first side being fixed with a ball recess for contacting and holding the ball and the second side being protruded with a pivotal part; wherein the pivotal part is formed with a third axial hole in the longitudinal direction; each of the pivoting bases faces each other by the first side thereof and is provided on the holding end of the corresponding holding arm; the pivotal part of each of the pivoting bases goes through between the two sub-arms of the corresponding holding arm; the second shaft goes through the third axial hole of the pivotal part of the pivoting base and the second axial hole of the first shaft, pivotally connecting the pivoting base on the first shaft; and the top ends of the two sub-arms of each of the holding arms is provided with an elastic chip to constrain the pivoting base to make small horizontal and longitudinal rotations on the corresponding holding arm.

2. The ball holding mechanism or claim wherein the bottom surface of the urging block is formed with a skewed cavity at the place urged by the transmission end of each of the holding arms, and the transmission end of each of the holding arms goes into and urges against the corresponding skewed cavity.

3. The ball holding mechanism of claim 1, wherein the base is formed with a through hole from the top surface to the bottom surface thereof, the central axis is a screw bar going through the through hole, the adjusting mechanism is a nut, and the nut is screw-fastened on the screw bar and urges against the bottom surface of the base from below.

4. The ball holding mechanism of claim 3, wherein the bottom surface of the urging block is formed with a skewed cavity at the place urged by the transmission end of each of the holding arms, and the transmission end of each of the holding arms goes into and urges against the corresponding skewed cavity.

5. The ball holding mechanism of claim 1, wherein the base is formed with a through hole from the top surface to the bottom surface thereof, the central axis is a screw bar going through the through hole, the adjusting mechanism includes a dynamical driving device and a transmission device, the transmission device is screw-fastened on the screw bar and urges against the bottom surface of the base from below, and the dynamical driving device drives the transmission device to displace the screw bar ups and downs.

6. The ball holding mechanism of claim 5, wherein the bottom surface of the urging block is formed with a skewed cavity at the place urged by the transmission end of each of the holding arms, and the transmission end of each of the holding arms goes into and urges against the corresponding skewed cavity.

7. The ball holding mechanism of claim 5, wherein the dynamical driving device is a motor and the transmission device is a gear or a belt wheel.

8. The ball holding mechanism of claim 7, wherein the bottom surface of the urging block is formed with a skewed cavity at the place urged by the transmission end of each of the holding arms, and the transmission end of each of the holding arms goes into and urges against the corresponding skewed cavity.
